(19) United States
(12) Patent Application Publication
(10) Pub. No.: US 2019/0378074 A1
(43) Pub. Date: Dec. 12, 2019

(54) METHOD, APPARATUS, AND SYSTEM FOR DATA ANALYTICS MODEL SELECTION FOR REAL-TIME DATA VISUALIZATION

(71) Applicant: The Strategy Collective dba BLKBOX, New York, NY (US)

(72) Inventors: Dionna MCPHATTER, New York, NY (US); Keenan BEASLEY, New York, NY (US)

(21) Appl. No.: 16/483,351

(22) PCT Filed: Feb. 2, 2018
(86) PCT No.: PCT/US18/16684

§ 371 Date: Aug. 2, 2019

Related U.S. Application Data
(60) Provisional application No. 62/453,820, filed on Feb. 2, 2017.

(51) Int. Cl. G06Q 10/06; G06N 20/20

(52) U.S. Cl. CPC G06Q 10/06375; G06N 20/20; G06Q 10/067

(57) ABSTRACT

An approach is provided for marketing performance management. An analytics platform receives a business scenario associated with an entity. The analytics platform also determines a perturbation of raw data associated with the business scenario. The analytics platform further selects one or more algorithms to determine a predictive machine learning model to process the raw data based on the perturbation of the raw data. The analytics platform further processes the raw data using the machine learning model to generate business intelligence data associated with the business scenario, and generates a user interface to present at least a portion of the business intelligence data on a device

### CROSS REFERENCE TO RELATED APPLICATIONS

This application claims the priority of a provisional Application of U.S. 62/453,820 filed Feb. 2, 2017, the content of which is incorporated herein by reference in its entirety.

### FIELD OF TECHNOLOGY

A data-driven consumer insight and content platform analyzing and visualizing understandings of how marketing performance impacts partner business, where to put investment in the future and an ability to tell a story through data.

### BACKGROUND

Data end users (e.g., marketing and sales professionals) are beginning to capture and analyze many different types of data on consumers—attitudinal, geographical, behavioral, and transactional—related to make predictions about future consumer behavior. Today's challenging environment is forcing more organizations to explore advanced analytics. Advanced Analytics (predictive, cognitive, behavioral, econometrics) commonly involves rigorous data analysis, and is widely used in business for segmentation and decision making, but have different purposes and the statistical techniques/models underlying them given the problem being solved. Accordingly, providers of data analytics and related services face significant technical challenges to aggregating the many different types of data into a format suitable for automated processing and selection of the model(s) that are to be used for analyzing and visualizing the business performance data, especially marketing performance data to gain insight and drive marketing planning.

### SOME EXAMPLE EMBODIMENTS

Therefore, there is a need for an approach for analyzing and visualizing the business performance data, especially marketing performance data to gain insight and drive marketing planning.

According to one embodiment, a method comprises receiving a business scenario associated with an entity. The method also comprises determining a perturbation of raw data associated with the business scenario. The method further comprises selecting one or more algorithms to determine a predictive machine learning model to process the raw data based on the determined perturbation of the raw data. The method further comprises processing the raw data using the selected machine learning model to generate business intelligence data associated with the business scenario. The method further comprises generating a user interface to present at least a portion of the business intelligence data on a device.

According to another embodiment, an apparatus comprises at least one processor, and at least one memory including computer program code for one or more computer programs, the at least one memory and the computer program code configured to, with the at least one processor, cause, at least in part, the apparatus to receive a business scenario associated with an entity. The apparatus is also caused to determine a perturbation of raw data associated with the business scenario. The apparatus is further caused to select one or more algorithms to determine a predictive machine learning model to process the raw data based on the determined perturbation of the raw data. The apparatus is further caused to process the raw data using the selected machine learning model to generate business intelligence data associated with the business scenario s. The apparatus is further caused to generate a user interface to present at least a portion of the business intelligence data on a device.

According to another embodiment, a non-transitory computer-readable storage medium carries one or more sequences of one or more instructions which, when executed by one or more processors, cause, at least in part, an apparatus to receive a business scenario associated with an entity. The apparatus is also caused to determine a perturbation of raw data associated with the business scenario. The apparatus is further caused to select one or more algorithms to determine a predictive machine learning model to process the raw data based on the determined perturbation of the raw data. The apparatus is further caused to process the raw data using the selected machine learning model to generate business intelligence data associated with the business scenario s. The apparatus is further caused to generate a user interface to present at least a portion of the business intelligence data on a device.

According to another embodiment, an apparatus comprises means for receiving a business scenario associated with an entity. The apparatus also comprises means for determining a perturbation of raw data associated with the business scenario. The apparatus further comprises means for selecting one or more algorithms to determine a predictive machine learning model to process the raw data based on the determined perturbation of the raw data. The apparatus further comprises means for processing the raw data using the selected machine learning model to generate business intelligence data associated with the business scenario. The apparatus further comprises means for generating a user interface to present at least a portion of the business intelligence data on a device.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

For various example embodiments, the following is applicable: An apparatus comprising means for performing the method of any of originally filed claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system for data analytics model selection for real-time data visualization, according to one embodiment;

FIG. 2 is a diagram of a framework for data analytics model selection for real-time data visualization, according to one embodiment;

FIG. 3 is a data architecture for data analytics model selection for real-time data visualization, according to one embodiment;

FIG. 4 is a diagram of the components of an analytics platform, according to an embodiment;

FIG. 5 is a flowchart of a process for applying a selected data analytics model selection for real-time data visualization, according to an embodiment;

FIG. 6. is a diagram illustrating graphical user interface for interacting with data visualizations tools, according to various embodiments;

FIG. 7 is a diagram illustrating a graphical user interface presenting an example optimized data visualization, according to one embodiment;

FIG. 8 is a diagram illustrating a graphical user interface presenting an example predicted data visualization, according to one embodiment

FIG. 9 is a diagram illustrating a graphical user interface presenting details of the example data visualization, according to one embodiment;

FIG. 10 is a diagram illustrating a graphical user interface presenting example simulations, according to one embodiment;

FIG. 11 is a diagram of a computer system that can be used to implement various exemplary embodiments; and

FIG. 12 is a diagram of a chip set that can be used to implement various exemplary embodiments.

### DESCRIPTION OF SOME EMBODIMENTS

Examples of a method, apparatus, system, and computer program for providing data analytics model selection for real-time data visualization are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention. According to Gartner Inc., “big data is high-volume and high-velocity and/or high-variety information assets that demand cost-effective, innovative forms of information processing that enable enhanced insight, decision-making, and process automation.” Big Data analytics find insights that help organizations make better business decisions. As noted above, Advanced Analytics (predictive, cognitive, behavioral, econometrics) commonly involves rigorous big data analysis, and is widely used in business for segmentation and decision making, but have different purposes and the statistical techniques/models underlying them given the problem being solved. However, such analytics generally are generally data intensive and rely on extensive amounts to data to improve analytical performance (e.g., accuracy, reliability, etc.). Accordingly, in many applications of Advanced Analytics, it is becoming increasingly necessary to consider uncertain data, e.g., information that is incomplete, unreliable, or noisy, while also maintaining analytical performance. These uncertain data present significantly technical challenges for automated processing because of the variety of available input formats, variety of analytical models available to process the data, and variety of available output formats/means. More specifically, the technical challenges, for instance, relate to how to ingest uncertain data of a variety of formats so that the data can be used to automatically select appropriate models for analyzing the data to output optimized data visualizations. Marketing performance management (MPM) refers to software and services that allow public and private entities to evaluate the performance of marketing campaigns. These organization intelligence tools identify and justify the effort and expense put into marketing campaigns by the entities. The existing business analytics use a fixed formula to measure past performance and guide marketing planning.

To address this problem, the system of the various embodiments described herein introduce a capability to efficiently calculate aggregation measures with a combination of business rules or objectives, over uncertain data. For example, the embodiments of the approaches described herein can develop new insights and understanding of marketing performance based on online and offline data and advantageously result in the use of a greater variety of available data sets to generate data visualizations that can potentially allow end users (e.g., marketers) to make better strategies for higher profitability and engagement. In one embodiment, the first step is to define the business question, rule, or objective that is relevant for the business. After figuring out the business question, the system can identify the types of data, analyses, models, visualizations, etc. that are related to the business question of a particular client. The system can then use automated means to execute the corresponding data ingestion, analytical model selection, and/or data visualizations in response to the business question tailored for the client's specific business context. In this way, end users (e.g., marketers or other partners) do not get bogged down in extracting and managing the data. Instead, the embodiments of the system or platform described herein can automatically manage the data for end users.

In one embodiment, the present disclosure provides for methods and apparatus for the aggregation of data. In a first aspect, a method of aggregating, analyzing and visualizing data in a computerized apparatus (“GUI”) and downloading out of the system into a format (e.g., pdf, ppt, xls, and/or any other format) “Presentable Form” is disclosed.

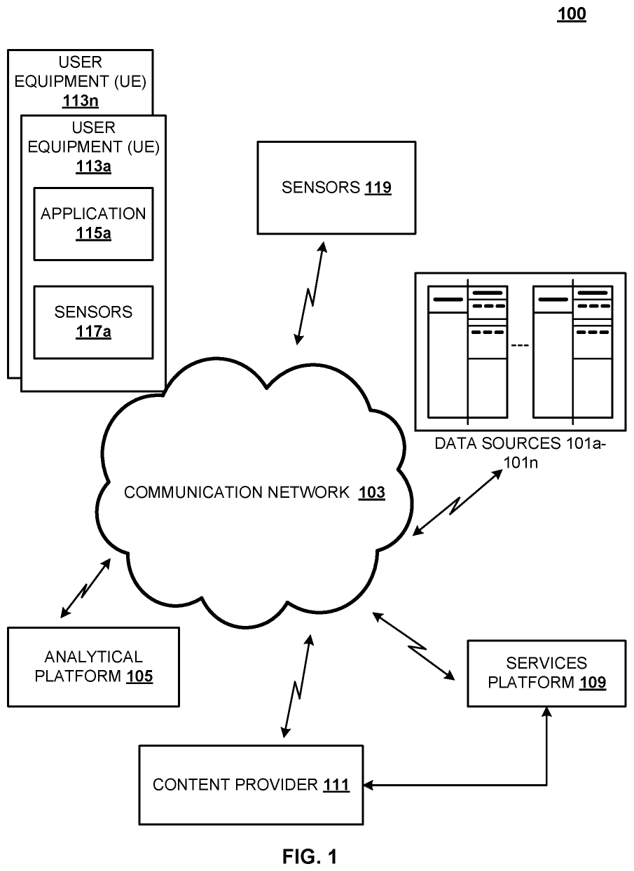

Analytics solutions need to scale to meet the demand for delivering results in real time while using large data sets and complex models. In one embodiment, the platform or system described herein achieves this through an analytical architecture outlined below and illustrated in the system for data analytics model selection for real-time data visualization of FIG. 1.

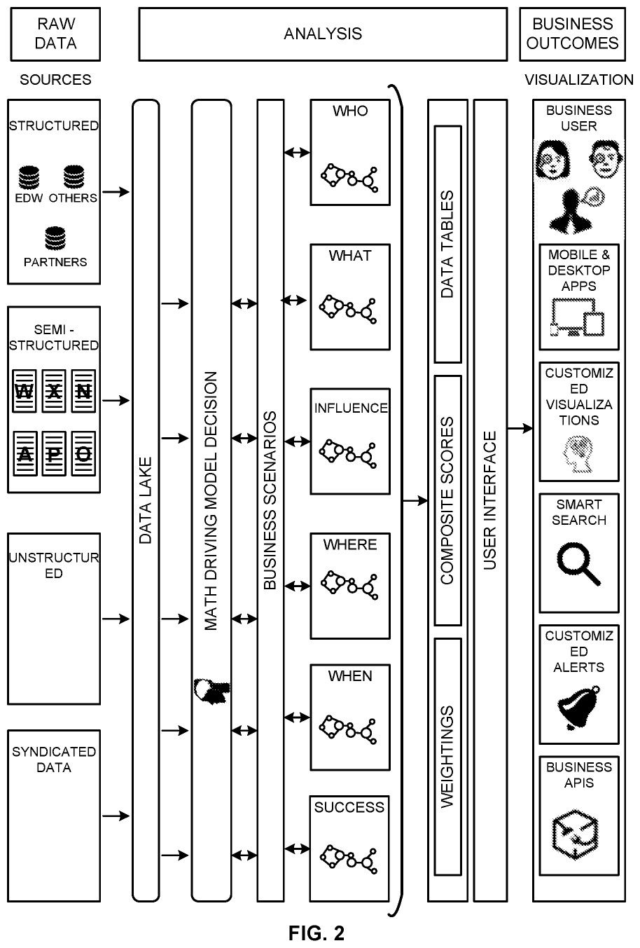

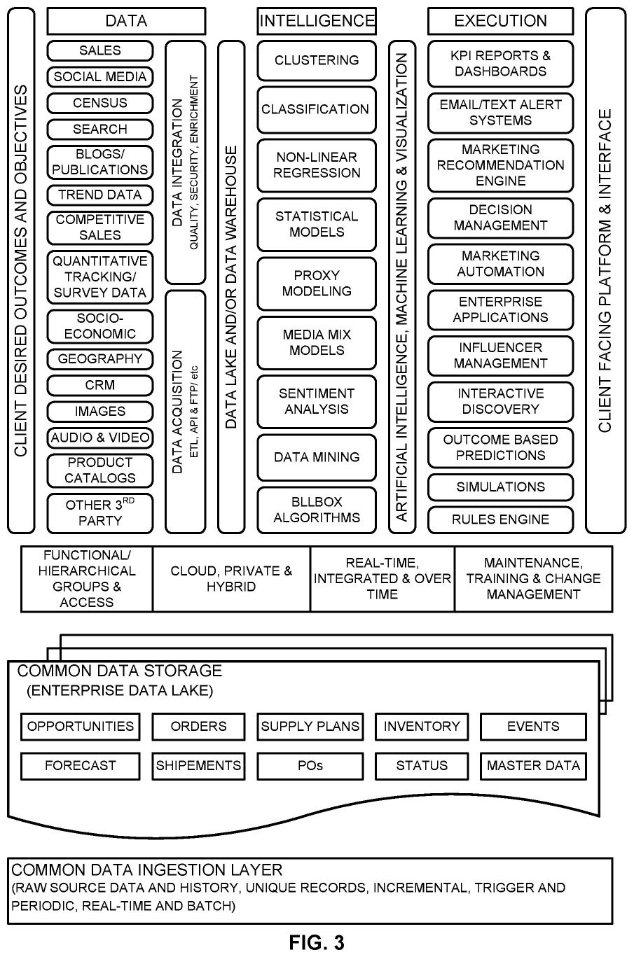

FIG. 1 is a diagram of a system for data analytics model selection for real-time data visualization, according to one embodiment. In one embodiment, the system of FIG. 1 illustrates a system 100 in which the platform or framework of FIG. 1 can be implemented. In this example, the analytics platform 105 performs the functions of the embodiments of the framework and data architecture described with respect to FIGS. 2-3. Examples of embodiments supported by the system 100 (and the framework and data architecture of FIGS. 2-3) include, but are not limited to the following.

One embodiment includes a method for data-informed decision making through the system 100 by marketers or other end users driven by both the nature of partner data and the question Quantum is trying to answer. This said method being characterized in that it includes the steps of: accounting, mapping, and valuing bias, benchmarks, industry analyses, and partner data. The method further comprises selecting an algorithm or predictive mode most effective against partner operating models and most effective business answers. The method further comprises using choice analytics to present multiple, sound favorite or winning scenarios for business. The method further comprises visualizing and presenting favorite or winning scenarios based on near and future timings for partner businesses.

In one embodiment, the method also comprises a step of extracting or analyzing data from big data stores with data from documents, emails, spreadsheets, the web and other databases to get further insights.

In one embodiment, the system 100 collects data without worrying about schemas and data descriptions automatically classifying the data, associated relationships and finds new relationships.

In one embodiment, the method further comprises using the framework and data architecture of FIGS. 2-3 to mine, determine and visualize: Value Proposition; Key Resources (including technology needs); Key Partners; Key Activities; Cost Structure; Channels; Consumer Relationships; Consumer Segments; Revenue Opportunities; and/or the like.

In one embodiment, the method further comprises determining the values displayed in the outer categories (e.g. “Who”, “What”, “Where”, “When”, “Influence”) within the GUI for aggregating, analyzing and visualizing data.

In one embodiment, the system 100 uses the framework of FIG. 2 and the data architecture of FIG. 3 to determine the values displayed in the inner categories (e.g. “Social Media”, “Influencer Marketing”) within the GUI for aggregating, analyzing and visualizing data.

In one embodiment, various elements of the system 100 may communicate with each other through a communication network 103. The communication network 103 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular communication network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), vehicle controller area network (CAN bus), and the like, or any combination thereof.

In one embodiment, the analytics platform 105 may be a platform with multiple interconnected components. The analytics platform 105 may include one or more servers, intelligent networking devices, computing devices, components and corresponding software for implementing a framework of FIG. 2. For example, the analytics platform 105 has connectivity to one or more data sources 101a-101n which store raw data sources for ingestion by the platform 105 according the embodiments described herein.

By way of example, one or more users (e.g., marketers, business users, etc.) may use any communications enabled computing device to access the analytics platform 105 and/or the data sources 101). In addition or alternatively, the functions of the analytics platform 105 may be provided by or via the services platform 109 and/or content provider 111.

In one embodiment, the services platform 109 may include any type of service. By way of example, the services platform 109 may include content provisioning services/application, application services/application, storage services/application, contextual information determination services/application, management service/application, etc. In one embodiment, the services platform 109 may interact with the analytics platform 105 and the content provider 111 to supplement or aid in the processing of the data analytics.

In one embodiment, the content providers 111, the user equipment 113a-113n, the sensors 119, or a combination thereof may provide content to the analytics platform 105. The content (e.g., raw data) provided may be any type of content, such as, image content, textual content, audio content, video content, sensor data, etc. that is not yet subject to manipulation by the analytics platform 105, software program(s), and/or analysist(s). In one embodiment, the content provider 111 may provide or supplement the content (e.g., audio, video, images, etc.) provisioning services/application, application services/application, storage services/application, contextual information determination services/application. In one embodiment, the content provider 111 may also store content associated with the analytics platform 105, and/or the services platform 109. In another embodiment, the content provider 111 may manage access to a central repository of data, and offer a consistent, standard interface to data, such as, a repository of the data ingested, processed, and/or outputted by the analytics platform 105.

Sensor technology is becoming ubiquitous in marketing attribution services and applications. For example, biometric sensors can help to measure, monitor, track, and improve marketing efforts. Similarly, environmental sensors are used to monitor and track consumer reactions to and interactions with marketing channels. The user equipment 113a-113n, such as mobile phones, have applications 115a-115n and built in sensors 117a-117n such as accelerometer, gyroscopes, GPS receivers, personal biometric sensors, environmental sensors, etc. The applications 115a-115n include analytics applications that determine what marketing media/channels are driving purchases. In one embodiment, the analytics applications of the UE 113a and the analytics platform 105 interact with each other according to a client-server model. According to the client-server model, a client process sends a message including a request to a server process, and the server process responds by providing a service (e.g., providing map information). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

The sensors 119 may be sensors attached to or embedded in a surveillance system, a human accessory object, home appliances (e.g., a refrigerator, a coffeemaker, a water filter, etc.), a garage door opener, a vehicle, a product, a bulletin board, a digital sign, etc.

In one embodiment, the system 100 uses sensors 117a-117n and heterogeneous sensors 119 to identify and/or verify consumers and detecting consumer interactions with products and/or marketing channels, e.g., including sensors in and/or on a person's body and/or in the environment (e.g., camera capturing a consumer's face, periocular region of the face, ear, iris, etc.; heartbeat via cardiac and pulmonary modulations detected using radar and/or Doppler effect). For example, in one use case, as a consumer walks to a digital sign at an airport terminal, sensors 119 near or of the digital sign can collect data about the consumer's device, walk, face, features, and context (e.g., location) prior to engaging with the digital sign at the airport terminal. In this way, the user's identity and marketing channel interaction can be identified/verified via sensor data.

By way of example, the analytics platform 105 may communicate with the databases 101, end user devices, and/or other components of the communication network 103 using well known, new or still developing protocols. In this context, a protocol includes a set of rules defining how the network nodes within the communication network 103 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

As shown in FIG. 2, in one embodiment, the framework includes raw data sources (e.g., sourced from sensors, partners, providers, data syndicators, and/or other data suppliers). The raw data sources can include multiple types of data with differing levels of certainty (e.g., certainty with respect to format, structure, accuracy, etc.). Data syndicators segment and syndicate data from various hubs and connected devices exist in homes, offices, public buildings, public transits, etc., and then stream requested data to various entities, such as businesses, non-profit organizations, government agencies, to determine which features, functionalities, and analysis are vital for the entities to pursue. By way of example, utility companies and smart cities with the sensor infrastructure can collect data such as utility usage data, traffic patterns, crime data, bus and train operating time, park/library utilization data, etc. which can be analyzed to provide insights for decision-making. As another example, a public health agency collects physiological data from personal smart devices, clinics, hospitals, pharmacies, etc., to generate a flu map and alerts to hot areas for flu.

For example, the raw data sources can include structured data that conform to a formal data structure of one or more databases used by the system or platform described herein. The raw data sources can also include semi-structured data (e.g., data with no formal structure, but include tags or other markers to indicate semantic elements or to indicate field or record structures within the data, such as documents, emails, spreadsheets), and/or unstructured data (e.g., data with no formal structure or organization, such as web data or documents).

FIG. 3 provides additional details of the types of raw data sources that can be used. For example, the data sources can include, but are not limited to: sales data, social media data, census data, search data, blogs/publications data, trend data, competitive sales data, quantitative tracking/survey data, socio-economic data, geographical data, consumer relationship management (CRM) data, image data, audio and video data, product catalog data, sensor data, and/or other third-party data. In one embodiment, the types of data, analyses to perform, and/or data visualizations or outputs are based on the client or user desired outcomes and objectives (e.g., the business question discussed above).

In one embodiment, the analysis portion of the framework of FIG. 2 ingests the relevant data sources (e.g., as stored in Hadoop common storage and ingested using a common data ingestion layer as shown in FIG. 3) to create a “data lake or warehouse”. In one embodiment, the data lake aggregates the raw data sources into a format or collection that is amenable or compatible for processing through the remaining components of the framework.

For example, as shown in FIG. 2, the math driving model decisioning module of the framework can process the ingested raw data sources in the data lake to determine which model(s) (e.g., predictive or statistical models) should be used to process the ingested mode to best meet the business question presented by the end user. As shown in FIG. 3, the types of intelligence or models to use can include, but are not limited to: clustering, classification, non-linear regression, statistical models, proxy modeling, media mix models, sentiment analysis, data mining, and/or any other configured proprietary algorithms. In one embodiment, these models form the basis of the artificial intelligence, machine learning, and/or visualization provided by the system or platform.

In one embodiment, the models selected by the math driving model decisioning module are used to evaluate business scenarios presented by the business question defined by the end user. For example, the models can be used to process ingested data to analyze factors such as who, what, influence, where, when, and/or predicted success. Based on this analysis, the system can determine weightings, composite scores, data tables, and/or the like with respect to the models, factors, business question, and scenarios associated with the business, etc.

As shown, the user interface of the framework can output the analysis, weightings, composite scores, data tables, and/or the like as visualizations of business outcomes responsive to the initial business question. By way of example, the visualizations are presented to the end user (e.g., business user) via mobile/desktop applications, customized visualizations, smart search results, customized alerts, or through application programming interfaces (APIs) (e.g., business APIs) for access by external applications and/or services.

In summary, the platform of FIG. 2 supplies visualization tools (user interface, data cache, mappings from horizontally scalable data store to data cache). The platform further supplies horizontally scalable data store and processing platform.

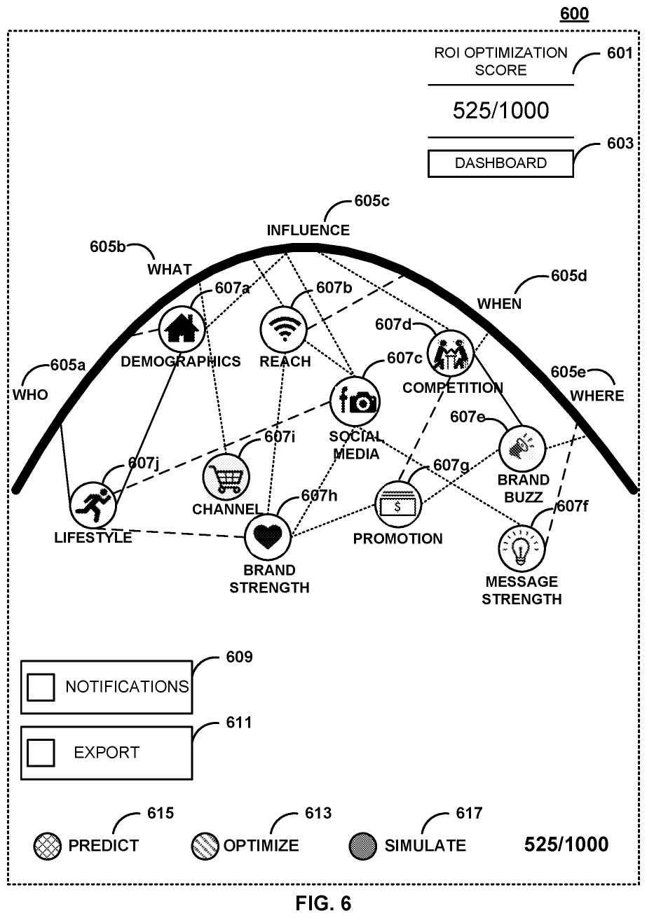

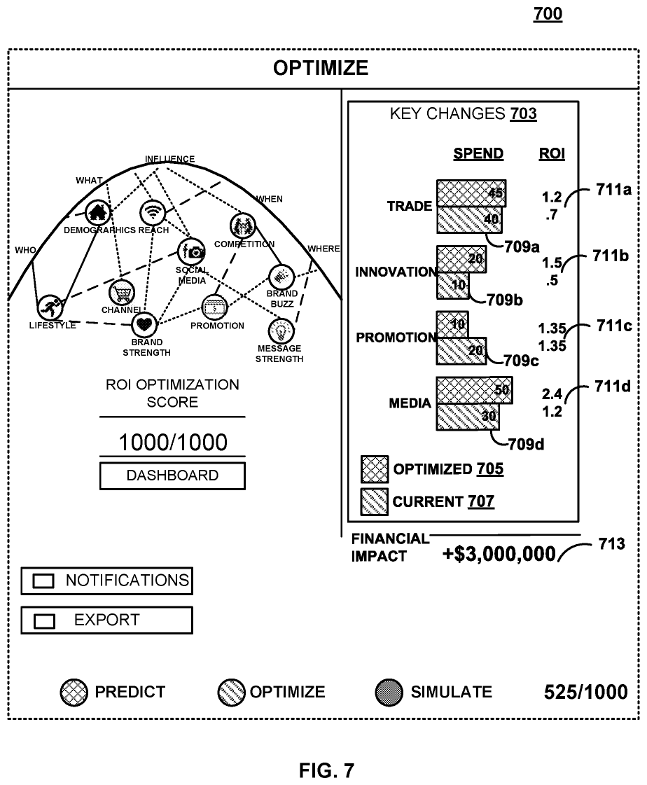

In one embodiment, the Data Consumer (“Partner”) uses the visualization tools to better understand the data. The system, for instance, uses techniques such as data mining, machine learning and semantic web for the build. Most of the services and algorithms are built in a technology-driven manner to drive an evergreen development of the Platform. This is due to: (1) users usually having few ideas about how the emerging technologies can support them (e.g., see technologies described in FIGS. 2-3); (2) problems described by users, such as “information overload”, “data silos everywhere” or “lack of holistic view”, (e.g., see FIGS. 3-5); and (3) goals set by decision makers often unclear, such as “find something valuable”, “get an impression”, understanding impact of key investment changes in the future performance (e.g., see FIG. 7), or “obtain deep understandings” (e.g., see FIG. 6).

In one embodiment, the GUI leverages the architecture principles articulated in the Model-view-controller (“MVC”) software design pattern for implementing GUIs. The system architecture directly manages the data, logic, and rules of the application in multiple parts. The first part is a view that can be any outputted representation of information, such as a chart or a diagram. Multiple views of the same information are possible, such as a bar chart for management and a tabular view for accountants. The third part, the controller, accepts input and converts it to commands for the model or view that are outputted via the GUI as illustrated, but not limited to the illustrations contained herein.

The Architecture for the platform illustrated in FIG. 2 is not limited to the constructional detail shown there or described in the accompanying Images and text. As those skilled in the art will understand, a suitable Architecture can be fabricated from multiple data sources, frameworks, methodologies, technologies, machines and models. In one embodiment, in order to be model-agnostic, the approach of the system does not “look” at models upfront. In order to figure out what parts of the interpretable input (e.g., ingested raw data sources) are contributing to the prediction (e.g., output or visualizations); the input is perturbed around its neighborhood and then “sees” how the model's predictions behave. The system can vary the input data over a predetermined range, generate predictions using each model. The output of the models over the tested ranges can be used to select which model is best for analyzing the data. For example, the “best” model can be selected by evaluating which models output predictions that most closely match a ground truth or known prediction. In other words, the system can apply an algorithm or other procedure for selecting models based on evaluating different perturbations of data against known or observed data. Then weighting is added to these perturbed data points by their proximity to the original example. In this way, the platform learns an interpretable model on those and the associated predictions.

Referring now to the invention in more detail, in FIG. 2 there is an architecture shown for the Quantum platform and how it receives, processes, models and visualizes data.

In further detail, still referring to FIG. 1 and also FIGS. 2 and 3, the information is processed based on data analytics model selection process described above and displayed for partners in a graphical user interface (“GUI”) that is powered from the architecture outlined in FIGS. 2-3.

In one embodiment, the construction details of the system as shown in FIGS. 1-3 are that the platform takes in volumes and velocity from multiple sources that allow for trust in the analyses and an immediate understanding by the end user. For example, the immediate understanding is facilitated based on coloring or other indicator of data presented in the GUI, where the coloring or other indicator is mapped to a legend or code that indicates which data, factors, models, etc. are driving the answers (e.g., predictions, visualizations, and/or other output) to the answers to the end user's (e.g., partner's) business question.

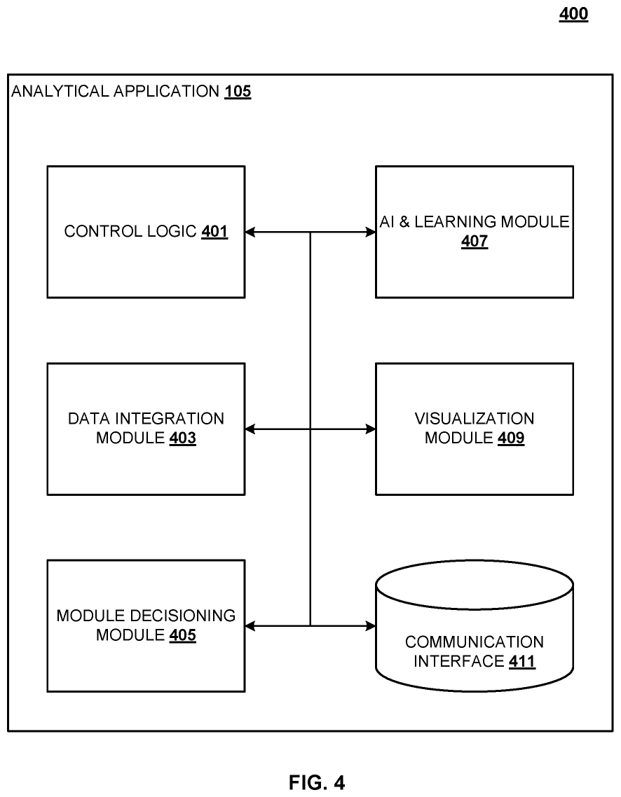

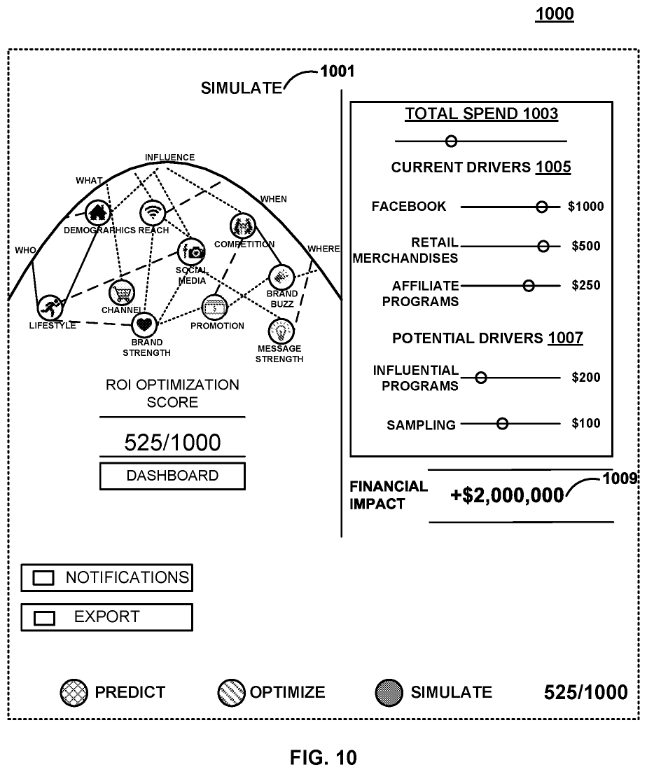

FIG. 4 is a diagram of the components of an analytics platform, according to an embodiment. The analytics platform 105 may comprise computing hardware (such as described with respect to FIG. 10), as well as include one or more components configured to execute the processes described herein for providing intent-based proximity marketing. It is contemplated that the functions of these components may be combined in one or more components or performed by other components of equivalent functionality. In certain embodiments, the analytics platform 105 includes a controller (or processor) 401, a data integration module 403, a math driving model decisioning module 405, an artificial intelligent and machine learning module 407, a visualization module 409, and a communication interface 411.

The controller 401 may execute at least one algorithm for executing functions of the analytics platform 105. For example, the controller 401 may interact with the data integration module 403 to convert raw data into a common data formats. When receiving a business scenario, the math driving model decisioning module 405 may selects one or more of the machine learning models based on a specific business scenario. In one embodiment, machine learning models include the different types of decision trees, random forest, neural networks, support vector machines, etc.

In general, a business scenario includes a set of background parameters that set a business use case, such as a marketing champion, in context. In one embodiment, a business scenario is defined by outer/main data categories (e.g. “Who”, “What”, “Where”, “When”, “Influence” and the values therein. In another embodiment, a business scenario is further defined by one or more sub-data category matrices of the outer/main data categories, and the values therein as the example shown in Table 1.

TABLE 1

| Main Data | | |
|---|---|---|
| Category | Sub-Data category matrices | Data Values |
| Who | Partner, Actor, Influencer, | e.g., Target {Demographic = 5, |
| | Target . . . | Lifestyle = 2, . . . } |
| What | Business, Product/ | e.g., {Business = 12, |
| | Service . . . | Product = 44, . . . } |
| Where | Geolocation, | e.g., {Geolocation = 112, |
| | Channel, Media . . . | Channel = 56, Media = 77 . . . } |
| When | Year, Seasons, Month, day, | e.g., {Year = 2019, |
| | time of the day . . . | Month = 3, . . . } |
| Influence | Consumer exposure rate, | e.g., {Click via = 9660, |
| | Conversion rate, Extended | Conversion = 3554, . . . } |
| | media exposure . . . | |

The artificial intelligent and machine learning module 407 uses the selected one or more models to determine values in the outer categories (e.g. “Who”, “What”, “Where”, “When”, “Influence”). Such values are processed and visualized by the visualization module 409 to desired formats/presentations to be displayed on a user interface.

The controller 401 may also work with the artificial intelligent and machine learning module 407 to determine purchase-related marketing interactions of individual consumers, consumer groups, etc., to trace marketing attributions and/or train the models. Various techniques and approaches may be utilized to trace marketing attributions and/or train the models.

The controller 401 may further utilize the communication interface 411 to communicate with other components of the analytics platform 105, the user equipment 113a-113n, and other components of the system 100. The communication interface 411 may include multiple means of communication. For example, the communication interface 411 may be able to communicate over short message service (SMS), multimedia messaging service (MMS), internet protocol, instant messaging, voice sessions (e.g., via a phone network), email, or other types of communication.

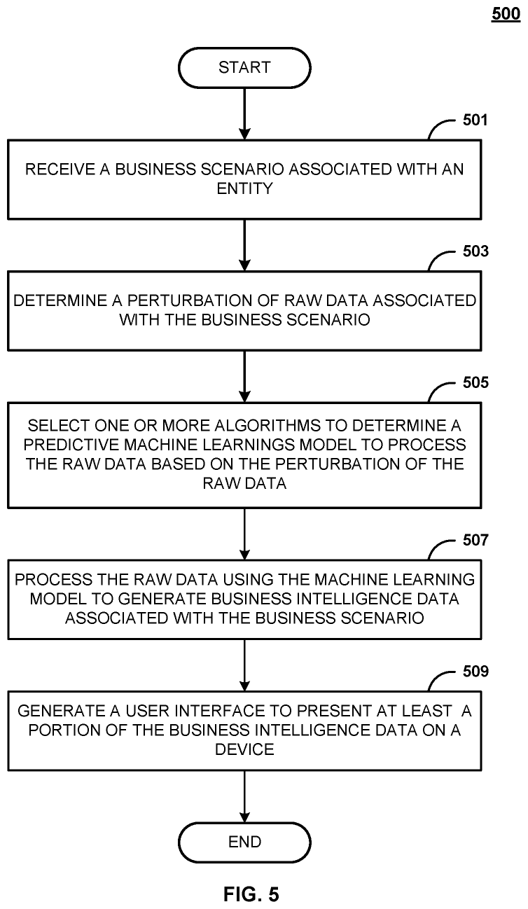

FIG. 5 is a flowchart of a process for applying a selected data analytics model selection for real-time data visualization, according to an embodiment. For the purpose of illustration, process 500 is described with respect to FIG. 1. It is noted that the steps of the process 500 may be performed in any suitable order, as well as combined or separated in any suitable manner.

In step 501, the analytics platform 105 receives a business scenario associated with an entity. For example, referring back to Table 1, the business scenario is for an outdoor gear company (e.g., “Business”=121) to determine the effectiveness of placing an advertisement poster (e.g., “Media”=77) of a new model of hiking boots (e.g., “Product”=44) on public bus waiting booths (e.g., “Channel”=56) to market to ages 20-50 people (e.g., “Demographic”=755) living in Washington D.C. (e.g., “Geolocation”=112).

In step 503, the analytics platform 105 determines a perturbation of raw data associated with the business scenario. Referring back to the hiking boots marketing champion, the perturbation of the raw data includes the sub-data category matrices and the values there in, such as Target {Demographic=5, Lifestyle=2, . . . }, {Business=12, Product=44, . . . }, {Geolocation=112, Channel=56, Media=77 . . . }, {Year=2019, Month=3 . . . }, {Click via=9660, Conversion=3554, . . . }, etc.

In one embodiment, the analytics platform 105 plans to retrieve raw data including sales data of the hiking boots and sale data of competing products, samples social media data of the target demographic group, blogs/publications data of the target demographic group, the hiking boots and competition products, trend data of the hiking boots and competing products, quantitative tracking/survey data of the hiking boots and competing products, socio-economic data of the target demographic group, consumer relationship management (CRM) data of the company, sensor data of the target group, etc.

In one scenario, for instance, the analytics platform 105 uses advanced automated data ingestion techniques to convert structured, semi-structured, and unstructured data into a common structure/format that can be used by the various components of the analytics platform 105. By way of example, the common format includes a consumer ID, a consumer group ID, a time, a location, a media ID, a marketing channel ID, a company ID, a product ID, a service ID, an interaction type, a weighting factor, or a combination thereof.

In step 505, the analytics platform 105 selects one or more algorithms to determine a predictive machine learning model to process the raw data based on the determined perturbation of the raw data. A machine learning model expresses mathematically the relevant causal relationships amount the factors, and optionally includes pipeline considerations (i.e., inventories) and market survey information. The machine learning model takes into account all known dynamics of the factors and utilizes predictions of related events such as competitors' actions and promotions. A machine learning model may incorporate results of a time series analysis.

In some embodiments, not all desirable raw data corresponding to the sub-data category matrices are available or cost-effective to obtain for external sources, the analytics platform 105 selects one or more algorithms to determine a predictive machine learning model to process the raw data based on the determined perturbation (e.g., availability) of the desirable raw data. Such availability data may be defined as whether the relevant data values are available, whether the relevant data values are within thresholds/ranges, whether the relevant data content format types (such as image, sensor, etc.) are available as shown in Table 2, etc.

TABLE 2

| Perturbation of Available Data | Model to Apply |
|---|---|
| Image content, Sensor data | Model A |
| Text content, Audio content | Model B |
| Video content, Sensor data | Model C |

In other embodiments, the analytics platform 105 selects the model depending on data factors such as the context of the product (e.g., a stage of the product's life cycle), the relevance and availability of historical product marketing and sale data, a degree of accuracy required, a marketing time period, a forecast time period, a cost/benefit of the analysis and marketing champion to the company, the time available for doing the analysis and marketing champion, etc. The analytics platform 105 weighs the factors in real-time to choose a combination of algorithms and model that makes the best use of available data, data sources, or a combination thereof.

In one embodiments, the analytics platform 105 gives a user options to readily apply one model of acceptable accuracy, to use a more advanced model that offers potentially greater accuracy but requires data with additional cost to obtain, or to split the afore options by percentage.

In one embodiment, among the available algorithm of partitioning, hierarchical, grid based, density based, and model based clustering algorithms, classification, filing data into non-linear regression models, sentiment analysis, and any other configured proprietary algorithms, the analytics platform 105 applies a Monte Carlo particle filter on phone call contents (e.g., including environmental cues), email messages, social media posts, etc. associated with mobile devices of the target group to derive time, locations, and marketing channel interactions of the target consumers visited prior to ordering a pair of hiking boots via an online auction website. The analytics platform 105 then applies a proprietary algorithm on the time, locations, and marketing channel interactions data to determine values in the outer categories (e.g. “Who”, “What”, “Where”, “When”, “Influence”), and attribute marketing effectiveness values of each relevant marketing channel the target consumers were exposed to.

The marketing effectiveness values (e.g., values indicating a target consumer's intent to purchase the hiking boots) may be based on purchase-related interactions initiated in the tracked process by the consumers, other users associated with the consumers, etc. As used herein, purchase-related interactions may refer to user interactions that are typically associated with purchasing a product or service, such as scanning a price tag of the product or service, searching for the product or service online, browsing information associated with the product or service, checking out with the product or service in a real-world or online shopping cart, etc. Moreover, in one embodiment, “intent to purchase” may be quantified by the number of times the consumer expresses an interest in a particular product or service—e.g., purchase-related interactions may be defined depending on the product or service, and a threshold can be set to trigger intent if the purchase-related interaction is performed in an amount to satisfy the threshold. For example, in one use case, sufficient “intent to purchase” a particular product may be shown by a consumer who has searched for the product on an online search engine, browsed information associated with the product, tried on the product at a physical store, and scanned a price tag of the product at the physical store.

In step 507, the analytics platform 105 processes the raw data using the selected machine learning model to generate business intelligence data associated with the business scenario. Such business intelligence data may include purchase-related interactions, revenue projection data, etc.

In one embodiment, the analytics platform 105 measures key metrics like revenue by reviewing the current process for deriving estimated revenue across all marketing channels using average conversion rates and a machine learning model based on past deal sizes, the number of touchpoints, and the quality of touchpoints for a standard compass, since the product has long history and stable sales. For example, if the company publishes an outdoor gear catalog in March, the company usually get x amount of leads in April and y amount of opportunities in May, and the analytics platform 105 forecasts revenue in May from z amount of sales using historical conversion rates for each channel and each type of content to determine how leads will flow through the funnel. When historical data are available and enough analysis has been performed to determine the relationships between the factor to be forecast (e.g., potential revenues) and other factors (such as related businesses, economic forces, socioeconomic factors, etc.), the analytics platform 105 constructs a machine learning model or selects one machine learning models from a model database.

In another embodiment, for a new product (such as a foot beauty mask) without historical conversion rates or machine learning models, the analytics platform 105 may adapt historical conversion rates or machine learning models of a similar product (e.g., a hand beauty mask) or a competing product offered by another company to forecast potential revenue from a marketing champion of the new product. If the product is so novel such that there is no similar or competing product available, the analytics platform 105 may use human/expert judgment and/or artificial intelligence to rate by matrices and schemes in order to build new casual models that turn qualitative information into quantitative estimates. When certain kinds of data are lacking, the analytics platform 105 makes assumptions about some casual relationships among the factors and then tracks the actual outcomes to determine if the assumptions are true. The analytics platform 105 continually revises/trains a machine learning model as more knowledge/data about the business scenario becomes available.

In another embodiment, the analytics platform 105 may apply a non-linear regression model for brand monitoring/tracking, which includes online and offline monitoring for communications and activities of brands/consumers, such as what consumers feel a brand and competitors' brands, from where consumers receive brand information (such as websites, consumer review application, social media posts, etc.), hashtags and keywords most relevant to the brand, etc. By way of example, the analytics platform 105 determines ten brand drivers that the company is recognized for out of over one million combinations.

In another embodiment, the analytics platform 105 may apply a sociological coding to the raw data to generate financial matrices, and incorporate advocacy, engagement and preferences.

In other embodiments, the analytics platform 105 may output key performance indicator (KPI) reports and dashboards, email/text alerts, states/predictions/recommendations of enterprise applications, marketing/influence management, etc., depending on the business scenario. By way of example, a KPI report includes the marketing effectiveness values that demonstrate how effectively the company is achieving or will achieve key hiking boots marketing objectives for the target group via each of the marketing channels.

In step 509, the analytics platform 105 generates a user interface to present at least a portion of the business intelligence data on a device. In one embodiment, the analytics platform 105 may simplify the formats/presentations of the time data, the locations data, the marketing channel interactions data, the marketing effectiveness values, the example outputs together with the company, the hiking boots and the competing products on a user interface as depicted in FIG. 6.

In one embodiment, the analytics platform 105 determines the portion of the business intelligence data to be presented based on one or more user context, one or more user selections, or a combination thereof. The user context may include the role, time restrains, objectives, etc., of the user that can be derived from the user's online and offline activities and interactions. The user selections may be entered via various user interfaces.

The analytics platform 105 then determines one or more formats for a condensed and intuitive presentation based on the values, the data categories, or a combination thereof of the portion of the business intelligence data. In this way, the analytics platform 105 may effectively provide proximity marketing return of a marketing champion (ROI), for instance, by utilizing the purchase intent information to generate customized content and recommendations of the content for presentation to the company user.

Subsequently, the analytics platform 105 may feed true data to train the artificial intelligence, the machine learning model. The true data is a reference set of perturbations of raw data that has been labeled or annotated with a corresponding true “business fact or condition” that corresponds to the business intelligence data, such as the discussed purchase-related interactions, revenue projection data, etc. In one embodiment, the true data includes actual marketing effectiveness values obtained via sales for the hiking boots champion.

Referring now to FIG. 6, there is shown a GUI 600 that pulls in data from a hierarchy created by the system using, for instance, the data analytics model selection process described above. In this example, the GUI shows a Return of Investment (ROI) optimization score 601 of as “525/1000” on a dashboard 603, the system 100 provides the ability (e.g., through the analytical process described above) to partners to access, evaluate, comprehend, and act on data faster and more effectively than ever before. In more detail, still referring to FIG. 6, his hierarchy determines the values shown in the inner metrics 607a-607j (e.g. Promotion, Social Media Strength) as well as the outer categories 605a-605e (e.g. “Who”, “What”, “Where”, “Influence”).

The system provides snapshots of a marketing champion to get a one-time assessment of a company's marketing performance in an intuitive framework that finally answers the “who” “why” behind the “what” to empower the company across functions with one version of the truth.

FIG. 6 also shows a Notification tab 609 to trigger a sub-window that support a user to set various alerts per data type, category, etc., at various frequencies and formats (e.g., visual alerts, audio alerts, email alerts, etc.), and an Export tab 611 to trigger a sub-window that support a user to set various data type and format for exporting data. FIG. 6 also shows an Optimize tab 613, a Predict tab 615, and a Simulate tab 617, which will be examined in more detail in view of FIGS. 7-10. The system moves beyond the basic analysis of the past and generate a data-driven agency ready brief in an intuitive format aligned to the company's brand objectives with key metrics built in from the start. The system evaluates a marketing campaign using a combination of metrics, content centralization, and analytics generate real-time, comprehensive visibility into what's working and what's not for the duration of a campaign with AI powered actionable recommendations.

FIG. 7 illustrates a graphical user interface 700 presenting an example optimized data visualization in response to a user selection of the Optimize tab 613, according to one embodiment. In this embodiment, an heading “Optimize” 701 and a panel of Key Changes 703 are added to the user interface, while the ROI optimization score on the dashboard is updated to “1000/1000” and moved to underneath the hierarchy of inner metrics. Within the Key Changes panel 703, optimized spending data 709a-709d are shown in one color 705 while the current spending data is shown in another color 707, and the relevant POI data are shown in numbers 711a-711d in four categories: Trade, Innovation, Promotion, and Media. In this case, the total finical impact (additional spending under optimization) 713 is $3,000,000.

The system reframes marketing discussions with predictive analytics that quantify brand affinity and link key equity metrics and messages to brand growth and sustainability.

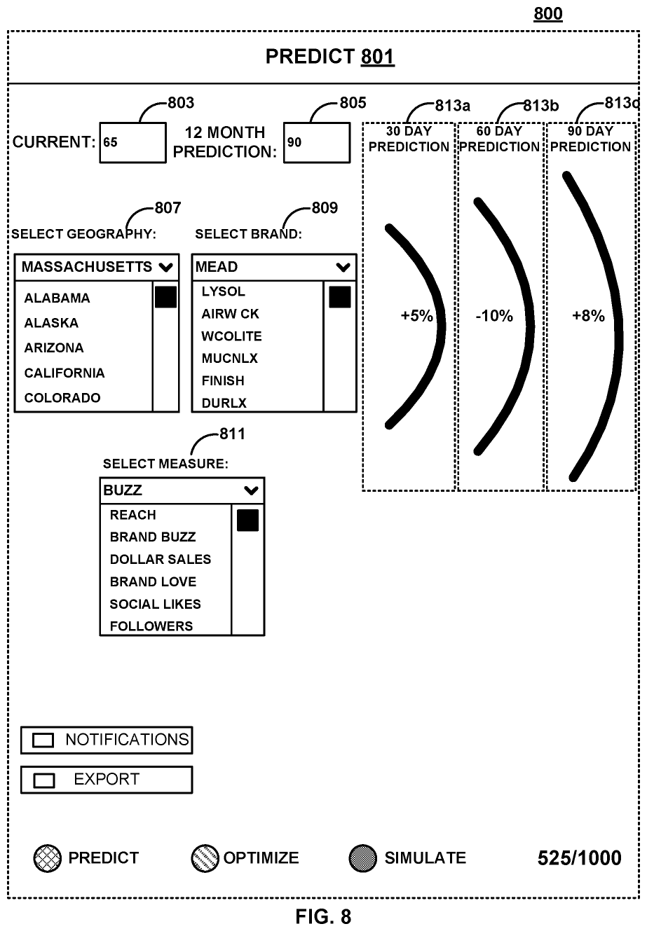

FIG. 8 illustrates a graphical user interface 800 interface presenting an example predicted data visualization in response to a user selection of the Predict tab 615, according to one embodiment. In this embodiment, a heading “Predict” 801 and other new features 803-813 are added to the user interface, while the ROI optimization score on the dashboard is removed. In this example, a Current filed 803 and a 12-month prediction field 805 show the respective sale numbers. A dropdown menu of “Select Geography” 807 allows a user to select a desired state “Massachusetts”, a dropdown menu of “Select Brand” 809 allows a user to select a desired brand “Mead,” and a dropdown menu of “Select Measure” 811 allows a user to select a measure “Buzz”. Next to the dropdown panels, three graphics show 30 days, 60 days and 90 days predicts of ROIs 813a-813c as “+5%”, “−10%”, and “+8%”. The system quickly demonstrates what will and could happen if you do A, B or C to accelerate changes to a marketing spend, tactics and messages with data-driven confidence. The system evaluates and quantifies opportunities outside of the company's current portfolio to inform investment, messaging and innovation decisions with clear consumer insights and predictive analytics.

In further detail, the GUI absorbs information in new and more constructive ways, visualize relationships and patterns between operational and business activities, identify and act on emerging trends faster, manipulate and interact directly with data through the analytical framework of FIG. 2.

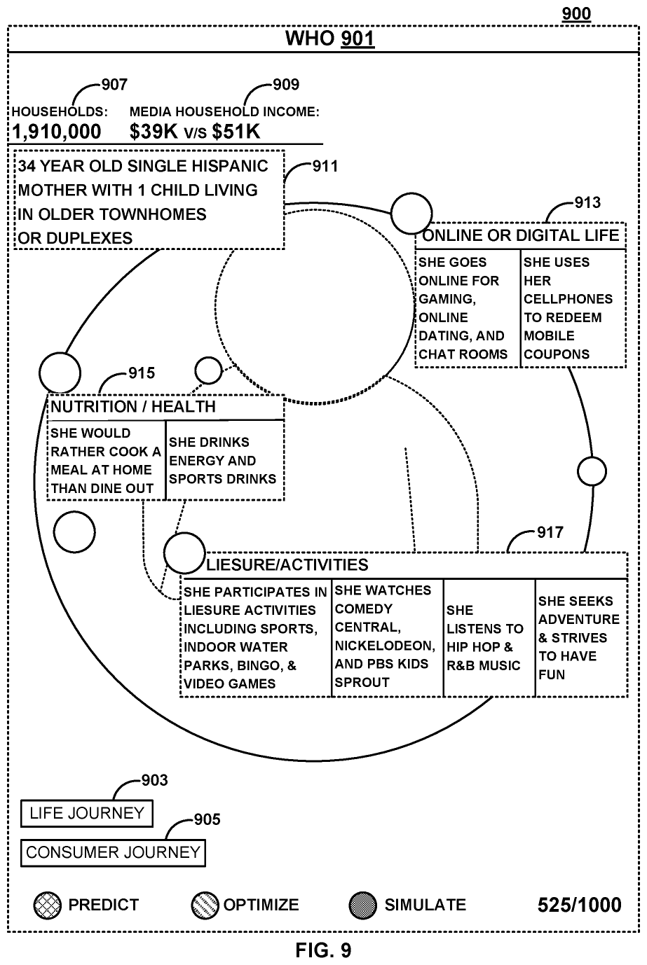

The system zooms into the target consumers' truth to isolate the impact of the consumer experience without losing the unified context to accurately understand how both offline and online retail tactics influence sale growth. FIG. 9 illustrates a graphical user interface 900 presenting details of the example data visualization of FIG. 6 in response to a user selection of the “Who” category 605a, according to one embodiment. In this embodiment, a heading “Who” 901, two product category tabs of “Life Journey,” “Consumer Journey” 903, 905, and other target consumer features 907-917 are shown in the user interface. In this case, the target consumer group includes 1,910,000 households (field 907) with median household incomes of $35k vs. $51k (field 909) and each household including one 34-year-old Hispanic single mother with one child living in an older townhouse or duplex (field 911). FIG. 9 includes Online/Digital Life field 913, Nutrition/Health field 915, and Leisure/Activities field 917 describing details of the target consumer group. The system goes beyond demographics and gets a detailed picture of exactly who matters to a brand whether the target consumers are buying the product or not. In one embodiment, the construction details of the system as shown in FIG. 9 are that the platform includes a capability to present a data visualization that tells a story through data. In Additionally, the platform or system may be made up of data sources, models and technologies any other sufficiently rigid and strong data sources, models and technologies.

FIG. 10 illustrates a graphical user interface 1000 presenting simulations based on the example of FIG. 6 in response to a user selection of the Simulate tab 617, according to one embodiment. In this embodiment, a heading “Simulate” 1001 and a panel of Total Spending 1003 are added to the user interface, while the ROI optimization score on the dashboard is moved to underneath the hierarchy of inner metrics. Within the Total Spending panel 1003, the user can slide scales of Current Drivers 1005 and/or scales of Potential Drivers 1007 to adjust the respective spending and a corresponding total finical impact (total spending under simulation) 1009 is $2,000,000. Here, there is shown a GUI that allows users to manipulate various measures that are determined by the analytical framework of FIG. 2 and see the results of their changes based on model selection and analysis to determine the inner metrics on the left of the image and/or a financial impact based on the predictions of the framework.

Table 3 below provides an example use case of the framework. It is noted that the example describes a marketing use case, but it is contemplated that the processes described herein are also applicable to any use case wherein data analytics model selection for real-time data visualization may be used.

TABLE 3

| | |
|---|---|
| ID: | Marketing Professionals |
| Title: | To understand their Marketing efforts to measure, adapt and develop |
| | better, more efficient Marketing strategies |
| Description: | Marketing Professional enters the GUI and begins to look at all data |
| | within the system then edits their view into analytical results that tells |
| | Marketing Professional how his/her marketing programs are really |
| | performing |
| Primary Actor: | Marketing Professional |
| Preconditions: | Marketing Professional logs into system |
| Postconditions: | Marketing Professional has reviewed information and downloads results |
| | into a Presentable Form |
| Main | Marketing Professional logs into system. Marketing Professional |
| Success Scenario: | selects outer category or inner metric query. Marketing Professional is |
| | brought to results of outer category or inner metric click through. |
| | Marketing Professional filters results based on predetermined scenarios. |
| | Marketing Professional receives final results. Marketing Professional |
| | downloads out of system into external Presentable Form. |
| Extensions: | Marketing Professional may send invite to link to colleague to share |
| | information otherwise delivered in Presentable Form. Marketing |
| | Professional changes results to look for past (historical) or future |
| | (forecasted and/or predicted) outcomes for inclusion into Presentable |
| | Form downloadable information. |

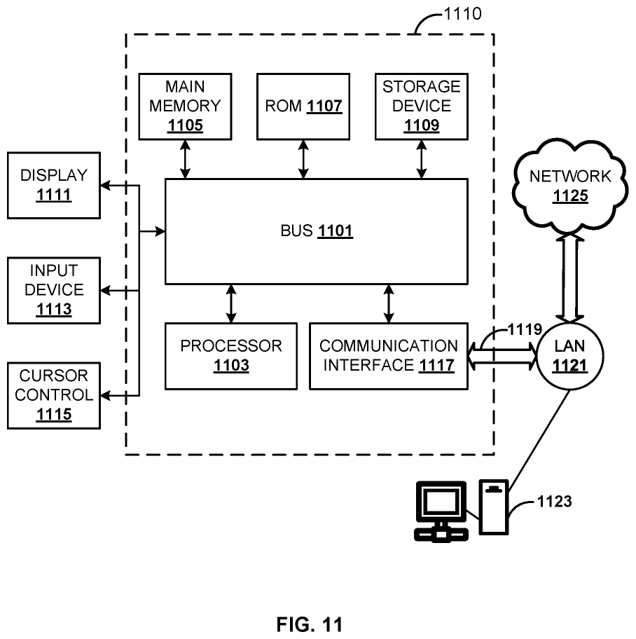

FIG. 11 is a diagram of a computer system that can be used to implement various exemplary embodiments. The computer system 1100 may be coupled via the bus 1101 to a display 1111, such as a cathode ray tube (CRT), liquid crystal display, active matrix display, or plasma display, for displaying information to a computer user. An input device 1113, such as a keyboard including alphanumeric and other keys, is coupled to the bus 1101 for communicating information and command selections to the processor 1103. Another type of user input device is a cursor control 1115, such as a mouse, a trackball, or cursor direction keys, for communicating direction information and command selections to the processor 1103 and for controlling cursor movement on the display 1111.

According to an embodiment of the invention, the processes described herein are performed by the computer system 1100, in response to the processor 1103 executing an arrangement of instructions contained in main memory 1105. Such instructions can be read into main memory 1105 from another computer-readable medium, such as the storage device 1109. Execution of the arrangement of instructions contained in main memory 1105 causes the processor 1103 to perform the process steps described herein. One or more processors in a multi-processing arrangement may also be employed to execute the instructions contained in main memory 1105. In alternative embodiments, hard-wired circuitry may be used in place of or in combination with software instructions to implement the embodiment of the invention. Thus, embodiments of the invention are not limited to any specific combination of hardware circuitry and software. The computer system 1100 may further include a Read Only Memory (ROM) 1107 or other static storage device coupled to the bus 1101 for storing static information and instructions for the processor 1103.

The computer system 1100 also includes a communication interface 1117 coupled to bus 1101. The communication interface 1117 provides a two-way data communication coupling to a network link 1119 connected to a local network 1121. For example, the communication interface 1117 may be a digital subscriber line (DSL) card or modem, an integrated services digital network (ISDN) card, a cable modem, a telephone modem, or any other communication interface to provide a data communication connection to a corresponding type of communication line. As another example, communication interface 1117 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1117 sends and receives electrical, electromagnetic, or optical signals that carry digital data streams representing various types of information. Further, the communication interface 1117 can include peripheral interface devices, such as a Universal Serial Bus (USB) interface, a PCMCIA (Personal Computer Memory Card International Association) interface, etc. Although a single communication interface 1117 is depicted in FIG. 9, multiple communication interfaces can also be employed.

The network link 1119 typically provides data communication through one or more networks to other data devices. For example, the network link 1119 may provide a connection through local network 1121 to a host computer 1123, which has connectivity to a network 1125 (e.g. a wide area network (WAN) or the global packet data communication network now commonly referred to as the “Internet”) or to data equipment operated by a service provider. The local network 1121 and the network 1125 both use electrical, electromagnetic, or optical signals to convey information and instructions. The signals through the various networks and the signals on the network link 1119 and through the communication interface 1117, which communicate digital data with the computer system 1100, are exemplary forms of carrier waves bearing the information and instructions.

The computer system 1100 can send messages and receive data, including program code, through the network(s), the network link 1119, and the communication interface 1117. In the Internet example, a server (not shown) might transmit requested code belonging to an application program for implementing an embodiment of the invention through the network 1125, the local network 1121 and the communication interface 1117. The processor 1103 may execute the transmitted code while being received and/or store the code in the storage device 1109, or other non-volatile storage for later execution. In this manner, the computer system 1100 may obtain application code in the form of a carrier wave.

The term “computer-readable medium” as used herein refers to any medium that participates in providing instructions to the processor 1103 for execution. Such a medium may take many forms, including but not limited to non-volatile media, volatile media, and transmission media. Non-volatile media include, for example, optical or magnetic disks, such as the storage device 1109. Volatile media include dynamic memory, such as main memory 1105. Transmission media include coaxial cables, copper wire and fiber optics, including the wires that comprise the bus 1101. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

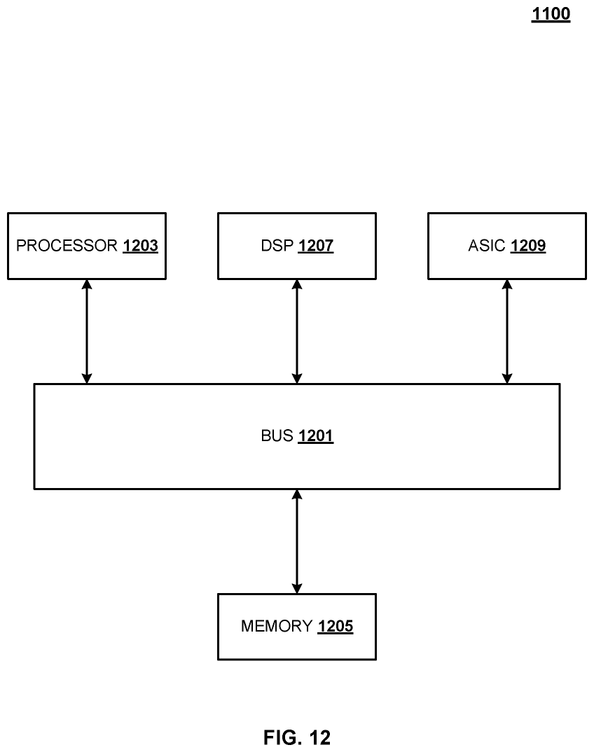

FIG. 12 illustrates a chip set 1200 upon which an embodiment of the invention may be implemented. Chip set 1200 is programmed to present a slideshow as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1200, or a portion thereof, constitutes a means for performing one or more steps of FIG. 5.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1205 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving a business scenario s associated with an entity;
determining a perturbation of raw data associated with the business scenario;
selecting one or more algorithms to determine a predictive machine learning model to process the raw data based on the determined perturbation of the raw data;
processing the raw data using the selected machine learning model to generate business intelligence data associated with the business scenario; and
generating a user interface to present at least a portion of the business intelligence data on a device.

2. A method of claim 1, further comprising:
determining the portion of the business intelligence data based on one or more user context, one or more user selections, or a combination thereof; and
determining one or more formats for the presentation based on one or more values, one or more data categories, or a combination thereof of the portion of the business intelligence data.

3. A method of claim 1, further comprising:
converting at least a portion of the raw data into a common format, wherein the portion of the raw data includes semi-structured data, unstructured data, or a combination thereof; and
ingesting the raw data in the common format into the selected machine learning model.

4. A method of claim 1, further comprising:
retrieving true data associated with the business scenario; and
training the selected machine learning model with the true data.

5. A method of claim 1, further comprising:
when determining a lack of raw data, a lack of a machine learning model, or a combination thereof that meets thresholds of a set of parameters of the business scenario, applying artificial intelligence to set assumed values for the set of parameters; and
generating a new machine learning model based on the assumed values.

6. A method of claim 1, wherein the one or more algorithms include clustering, classification, non-linear regression, sentiment analysis, or a combination thereof.

7. A method of claim 1, wherein the raw data includes image content, textual content, audio content, video content, sensor data, or a combination thereof.

8. An apparatus comprising:
at least one processor; and
at least one memory including computer program code for one or more programs,
the at least one memory and the computer program code configured to, with the at least one processor, cause the apparatus to perform at least the following,
receive a business scenario s associated with an entity;
determine a perturbation of raw data associated with the business scenario;
select one or more algorithms to determine a predictive machine learning model to process the raw data based on the determined perturbation of the raw data;
process the raw data using the selected machine learning model to generate business intelligence data associated with the business scenario; and
generate a user interface to present at least a portion of the business intelligence data on a device.

9. An apparatus of claim 8, wherein the apparatus is further caused to:
determine the portion of the business intelligence data based on one or more user context, one or more user selections, or a combination thereof; and
determine one or more formats for the presentation based on one or more values, one or more data categories, or a combination thereof of the portion of the business intelligence data.

10. An apparatus of claim 8, wherein the apparatus is further caused to:
convert at least a portion of the raw data into a common format, wherein the portion of the raw data includes semi-structured data, unstructured data, or a combination thereof; and
ingest the raw data in the common format into the selected machine learning model.

11. An apparatus of claim 8, wherein the apparatus is further caused to:
retrieve true data associated with the business scenario; and
train the selected machine learning model with the true data.

12. An apparatus of claim 8, wherein the apparatus is further caused to:
when determining a lack of raw data, a lack of a machine learning model, or a combination thereof that meets thresholds of a set of parameters of the business scenario, apply artificial intelligence to set assumed values for the set of parameters; and
generating a new machine learning model based on the assumed values.

13. An apparatus of claim 8, wherein the one or more algorithms include clustering, classification, non-linear regression, sentiment analysis, or a combination thereof.

14. An apparatus of claim 8, wherein the raw data includes image content, textual content, audio content, video content, sensor data, or a combination thereof.

15. A non-transitory computer-readable storage medium carrying one or more sequences of one or more instructions which, when executed by one or more processors, cause an apparatus to at least perform the following steps:
receiving a business scenario s associated with an entity;
determining a perturbation of raw data associated with the business scenario;
selecting one or more algorithms to determine a predictive machine learning model to process the raw data based on the determined perturbation of the raw data;
processing the raw data using the selected machine learning model to generate business intelligence data associated with the business scenario; and
generating a user interface to present at least a portion of the business intelligence data on a device.

16. A non-transitory computer-readable storage medium of claim 15, wherein the apparatus is caused to further perform:
determining the portion of the business intelligence data based on one or more user context, one or more user selections, or a combination thereof; and
determining one or more formats for the presentation based on one or more values, one or more data categories, or a combination thereof of the portion of the business intelligence data.

17. A non-transitory computer-readable storage medium of claim 15, wherein the apparatus is caused to further perform:
converting at least a portion of the raw data into a common format, wherein the portion of the raw data includes semi-structured data, unstructured data, or a combination thereof; and
ingesting the raw data in the common format into the selected machine learning model.

18. A non-transitory computer-readable storage medium of claim 15, wherein the apparatus is caused to further perform:
retrieving true data associated with the business scenario; and
training the selected machine learning model with the true data.

19. A non-transitory computer-readable storage medium of claim 15, wherein the apparatus is caused to further perform:
when determining a lack of raw data, a lack of a machine learning model, or a combination thereof that meets thresholds of a set of parameters of the business scenario, applying artificial intelligence to set assumed values for the set of parameters; and
generating a new machine learning model based on the assumed values.

20. A non-transitory computer-readable storage medium of claim 15, wherein the one or more algorithms include clustering, classification, non-linear regression, sentiment analysis, or a combination thereof.
